(19) United States
(12) Patent Application Publication
(10) Pub. No.: US 2026/0213087 A1
(43) Pub. Date: Jul. 23, 2026

(54) MANUAL OVERRIDE SAFETY RESTRICTOR AND MANUAL OVERRIDE COVER FOR MAKING ELECTRICAL CONTROL AND MANUAL CONTROL OF A MICROGRID INTERCONNECT DEVICE RELAY MUTUALLY EXCLUSIVE

(71) Applicant: EATON INTELLIGENT POWER LIMITED, DUBLIN 4 (IE)

(72) Inventors: Suhas Vishwanath Dhakate, Pune (IN); Manish Prabhakar Kesarkar, Pune (IN); Mahesh Ighe, Pune (IN); Sandip Nagtilak, Pandharpur (IN)

(73) Assignee: EATON INTELLIGENT POWER LIMITED, DUBLIN 4 (IE)

(21) Appl. No.: 19/033,200

(22) Filed: Jan. 21, 2025

(51) Int. Cl. H01H 9/02; H01H 15/14; H01H 15/24; H01H 50/02

(52) U.S. Cl. CPC H01H 9/02; H01H 15/14; H01H 15/24; H01H 50/021

(57) ABSTRACT

A safety system is provided for an MID with a manual override switch movable between an OFF (grid-forming) position and an ON (grid-following) position, the MID being installed in a load panel having a dead front cover. The safety system includes an MID front cover having an opening that makes the override switch accessible, a switch guard, an override cover, a limit switch, and a controller. The switch guard is positioned in the opening of the MID front cover, and the override cover is coupled to the switch guard. The override cover does not engage the limit switch when open and engages the limit switch when closed. The controller disables electrical control of the MID relay when the limit switch is unengaged. The switch guard prevents the override switch from moving to the ON position and can only be removed from the opening when the dead front cover is uninstalled.

### FIELD OF THE INVENTION

The disclosed concept relates generally to relay switches, and in particular, to manual override mechanisms for relays of microgrid interconnect devices (MIDs).

### BACKGROUND OF THE INVENTION

DER (distributed energy resource) systems are relatively small-scale power sources that generate electricity on-site for individual electricity consumers and can be interconnected to the utility electrical grid. DERs enable a consumer to supplement and sometimes replace their use of utility power and can also sometimes supply/backfeed power to the utility grid. A microgrid interconnection device (MID) is used to monitor and manage a microgrid’s connection and disconnection between a utility power source and DER systems. When a DER is connected to the utility grid, the DER is said to be in grid-following mode, and when a DER is isolated from the utility grid and is driving the loads, the DER is said to be in grid-forming mode. There are several safety considerations that must be kept in mind when using an MID to manage the connection and disconnection of a microgrid to and from utility power and DER systems. Two such considerations are manual override control and restricting the conditions under which a DER connected to the MID can be put into grid-following mode.

Regarding manual override control, UL 1741 requires that a relay switch used with DER systems (such as an MID relay switch) be configured so that electrical control of the relay switch and manual control of the relay switch are mutually exclusive. Relays that fulfill the UL 1741 requirement are not directly available in the market. Relays typically include a solenoid used to effectuate electrical control of the relay switch and a manual override switch that can be physically moved by a user in order actuate the relay switch. The relays available in the market have a physical linkage between the solenoid actuation and the physical manual override switch, hence, the manual switch will be actuated ON/OFF when the electrical switch is actuated ON/OFF and vice versa. For an existing relay switch, customizing the relay switch in order to make electrical control of the relay switch and manual control of the relay switch mutually exclusive would involve significant time and cost.

Regarding restricting the conditions under which a DER connected to the MID can be put into grid-following mode, it is usually preferable to only enable grid-following mode using automated electrical means that are configured to ensure that the DER is synchronized with the grid or that the DER has turned off its high voltage output prior to enabling grid-following mode for the DER. Restricting the conditions under which grid-following mode can be manually enabled for a DER is important, because enabling grid-following mode when the DER is not synchronized with the grid and when the DER high voltage output is not turned off can be both dangerous to nearby personnel and can cause damage to the power distribution system.

There is thus room for improvement in relay switches used with DER systems and in manual override mechanisms therefor.

### SUMMARY OF THE INVENTION

These needs, and others, are met by a disclosed safety system for an MID with a manual override switch movable between an OFF position (grid-forming) and an ON position (grid-following), the MID being installed in a load panel having a dead front cover. The safety system includes an MID front cover having an opening that makes the override switch accessible, a switch guard, an override cover, a limit switch, and a controller. The switch guard is coupled to the MID front cover and positioned in the opening of the MID front cover. The override cover is coupled to the switch guard. The override cover does not engage the limit switch when open and engages the limit switch when closed. The controller disables electrical control of the MID relay when the limit switch is unengaged. The switch guard prevents the override switch from moving to the ON position and can only be uncoupled from the MID front cover and removed from the opening when the dead front cover is uninstalled.

In accordance with one aspect of the disclosed concept, a manual override safety system is provided for an MID installed in a load panel. The load panel includes a load panel housing with a dead front cover. The MID includes a relay device and a manual override switch that can be manually actuated in a depth dimension between an OFF position corresponding to the relay device being in a grid-forming state and an ON position corresponding to the relay device being in a grid-following state. The manual override safety system comprises: an MID front cover, a switch guard, a manual override cover, a limit switch, and a controller. The MID front cover comprises an opening structured to make the manual override switch accessible for manual actuation. The switch guard is structured to be positioned fully within the opening and coupled to the MID front cover. The manual override cover is structured to be coupled to the switch guard. The limit switch is covered by the MID front cover and comprises: a main switch body, and a switch lever. The switch lever is structured to be actuated between an unengaged position and an engaged position. The controller is in electrical communication with the limit switch. The manual override cover is structured to be moved between an open position and a closed position such that the manual override cover exposes the manual override switch in the open position and covers the manual override switch in the closed position. The manual override cover and the limit switch are positioned such that the manual override cover being in the open position causes the switch lever to be in the unengaged position and such that the manual override cover being in the closed position causes switch lever to be in the engaged position. The controller is configured to disable electrical control of the relay device when the switch lever is in the unengaged position. The switch guard is structured such that, when coupled to the MID front cover and positioned fully within the opening, the switch guard obstructs the manual override switch from being actuated to the ON position.

In accordance with another aspect of the disclosed concept, a manual override safety system is provided for an MID installed in a load panel. The load panel includes a load panel housing with a dead front cover. The MID includes a relay device and a manual override switch that can be manually actuated in a depth dimension between an OFF position corresponding to the relay device being in a grid-forming state and an ON position corresponding to the relay device being in a grid-following state. The manual override safety system comprises: an MID front cover, a switch guard, a manual override cover, a limit switch, and a controller. The MID front cover comprises: an opening structured to make the manual override switch accessible for manual actuation, and an arm stop ledge adjacent the opening. The opening extends in the depth dimension and a width dimension, with the width dimension being orthogonal to the depth dimension. The switch guard is structured to be positioned fully within the opening and coupled to the MID front cover. The manual override cover is structured to be coupled to the switch guard and comprises: a main cover body, and a switch engaging arm. The limit switch is covered by the MID front cover and comprises: a main switch body, and a switch lever. The switch lever is structured to be actuated between an unengaged position and an engaged position. The controller is in electrical communication with the limit switch. The manual override cover is structured to be moved between an open position and a closed position such that the manual override cover exposes the manual override switch in the open position and covers the manual override switch in the closed position. The manual override cover and the limit switch are positioned such that the manual override cover being in the open position causes the switch lever to be in the unengaged position and such that the manual override cover being in the closed position causes switch lever to be in the engaged position. The controller is configured to disable electrical control of the relay device when the switch lever is in the unengaged position. The switch guard is structured such that, when coupled to the MID front cover and positioned fully within the opening, the switch guard obstructs the manual override switch from being actuated to the ON position.

### BRIEF DESCRIPTION OF THE DRAWINGS

A full understanding of the invention can be gained from the following description of the preferred embodiments when read in conjunction with the accompanying drawings in which:

FIG. 1 is a front perspective view of a load panel that includes an MID and a manual override safety system for the MID, in accordance with an example embodiment of the disclosed concept;

FIG. 2A is an enlarged view of the manual override safety system shown in FIG. 1, showing a manual override switch cover of the system in an open position, in accordance with an example embodiment of the disclosed concept;

FIG. 2B is a symbolic depiction of the circuit that disables electrical control of the MID relay device in FIG. 2A, in accordance with an example embodiment of the disclosed concept;

FIG. 3A is an enlarged view of the manual override safety system shown in FIG. 1, showing the manual override switch cover in a closed position, in accordance with an example embodiment of the disclosed concept;

FIG. 3B is a symbolic depiction of the circuit that enables electrical control of the MID relay device in FIG. 3A, in accordance with an example embodiment of the disclosed concept;

FIG. 4A is a front perspective view of the load panel shown in FIG. 1 with the dead front cover removed from the load panel housing;

FIG. 4B is an enlarged view of a portion of FIG. 4A that shows a switch guard of the manual override safety system, in accordance with an example embodiment of the disclosed concept;

FIG. 5 shows the view shown in FIG. 4B rotated and with the switch guard removed;

FIG. 6 shows the view shown in FIG. 5 slightly enlarged and with the MID manual override switch having been manually actuated to an ON/grid-forming position in the absence of the switch guard;

FIG. 7 is a view from a similar perspective as FIGS. 5-6 showing the dead front cover installed on the load panel housing and removal of the switch guard being obstructed by the dead front cover;

FIG. 8 shows a view from a similar perspective as FIG. 4B, with the switch guard being uncoupled from the MID front cover after the dead front cover has been uninstalled from the load panel housing;

FIG. 9A is an enlarged view of the manual override safety system shown in FIG. 1, showing a variation of the manual override cover shown in FIGS. 2A and 3A, with the manual override cover coupled to the switch guard in a closed position, in accordance with another example embodiment of the disclosed concept;

FIG. 9B shows the manual override cover and switch guard of FIG. 9A in an exploded view in order to make certain features of the switch guard and manual override cover more apparent; and

FIG. 10 is a rotated and enlarged portion of the view shown in FIG. 9A showing the motion used to open or remove the manual override cover from the switch guard.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As employed herein, employed herein, when ordinal terms such as “first” and “second” are used to modify a noun, such use is simply intended to distinguish one item from another, and is not intended to require a sequential order unless specifically stated.

As employed herein, the term “controller” shall mean a programmable analog and/or digital device that can store, retrieve and process data; a processor; a control circuit; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, the term “number” shall mean one or an integer greater than one (i.e., a plurality).

As previously stated, the UL 1741 standard requires manual override switching in relay devices used in conjunction with DERs. Specifically, UL 1741 prohibits a relay device’s electrical switching mechanism (e.g. solenoid) from overriding the state of the relay device’s manual override switch. It will be appreciated that many modern electrical systems allow a user to remotely actuate switching, for example and without limitation through the use of a mobile phone app. As such, a modern relay device’s electrical control capabilities may be actuated either automatically, by a DER, or remotely by a user through means such as a mobile app. Disclosed herein is an innovative manual override safety system 100 for a microgrid interconnect device (MID) that ensures: (1) that electrical control of the MID’s relay device is disabled when the MID relay device’s manual override switch is being used or when use of the manual override switch is imminent, and (2) that the MID will not manually be put into grid-following mode unless a series of specific actions are taken that should not be taken by anyone other than qualified personnel.

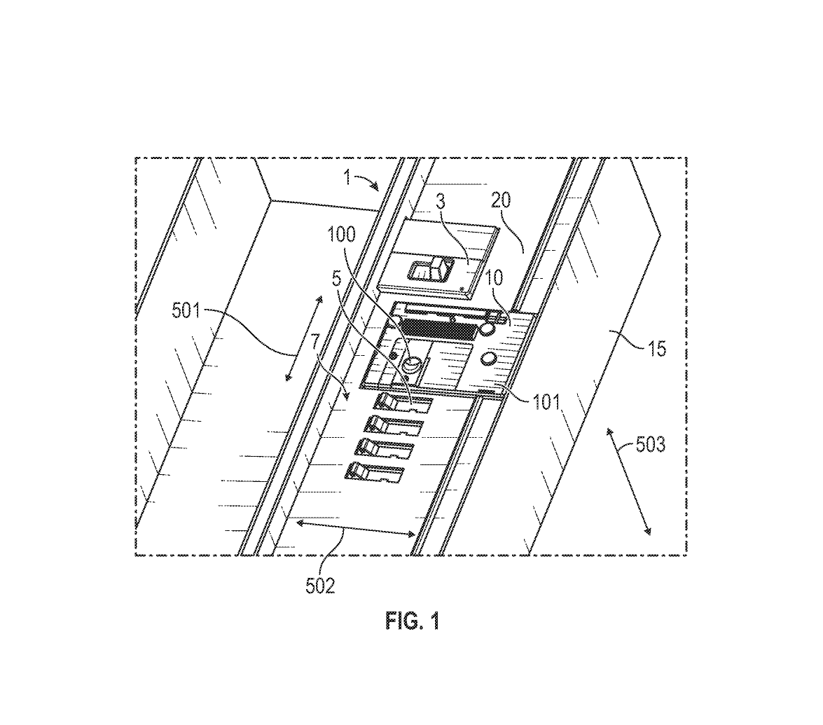

FIG. 1 shows a load panel 1 that includes a main circuit breaker 3 (referred to hereinafter as the “main breaker 3” for brevity), a plurality of branch circuit breakers 5 (referred to hereinafter as the “branch breakers 5” for brevity), and an MID 10 all contained in a load panel housing 15 that includes a dead front cover 20. The dead front cover 20 prevents the live electrical components of the load panel 1 from being accessible while the load panel 1 is energized and is structured to be removed from the load panel housing 15 as necessary to perform maintenance on or service the load panel 1.

The MID 10 includes the aforementioned manual override safety system 100 disclosed in accordance with an exemplary embodiment of the disclosed concept, as detailed further later herein. The MID 10 and branch breakers 5 are all downstream of the main breaker 3. Each of the branch breakers 5 is structured to be connected to a number of loads. The MID 10 is structured to be connected to a number of distributed energy resource (DER) systems. The main breaker 3 has a main bus 7 (not visible in the figures), and it will be appreciated that the branch breakers 5 and the MID 10 are connected to the main bus 7. The main breaker 3 is structured to be connected to utility power, and to connect the branch breakers 5 and the MID 10 to utility power when the main breaker 30 is closed. The MID is structured to manage connection and disconnection of each of the DER systems to the main bus 7, taking into account whether or not the main bus 7 is connected to utility power.

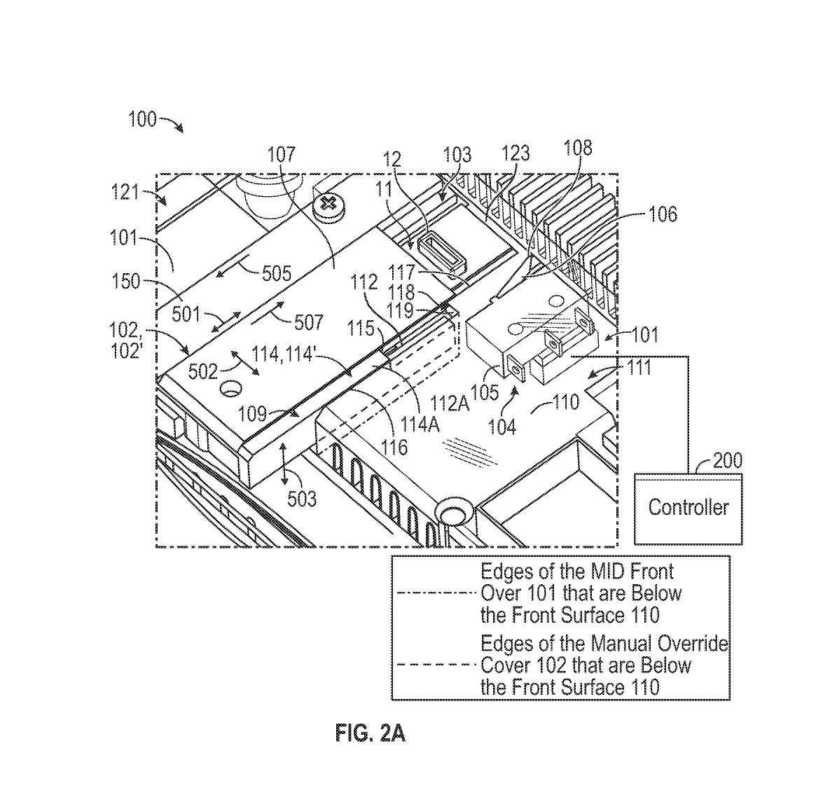

As previously noted, when a DER is connected to the utility grid, the DER is said to be in grid-following mode, and when a DER is isolated from the utility grid, the DER is said to be in grid-forming mode. The MID 10 comprises a relay device 11 (numbered in FIG. 2A) structured to be actuated between an ON position and an OFF position, the ON position corresponding to the MID 10 being in an ON state and the OFF position corresponding to the MID 10 being an OFF state. When the relay device 11 is in the ON state, the relay device forms a closed current path that can conduct current between the DER systems and the main bus 7, allowing the DER systems to be in grid-following mode. When the relay device is in the OFF state, the relay device forms an open current path that prevents conduction of current between the DER systems and the main bus 7, allowing the DER systems to be in grid-forming mode.

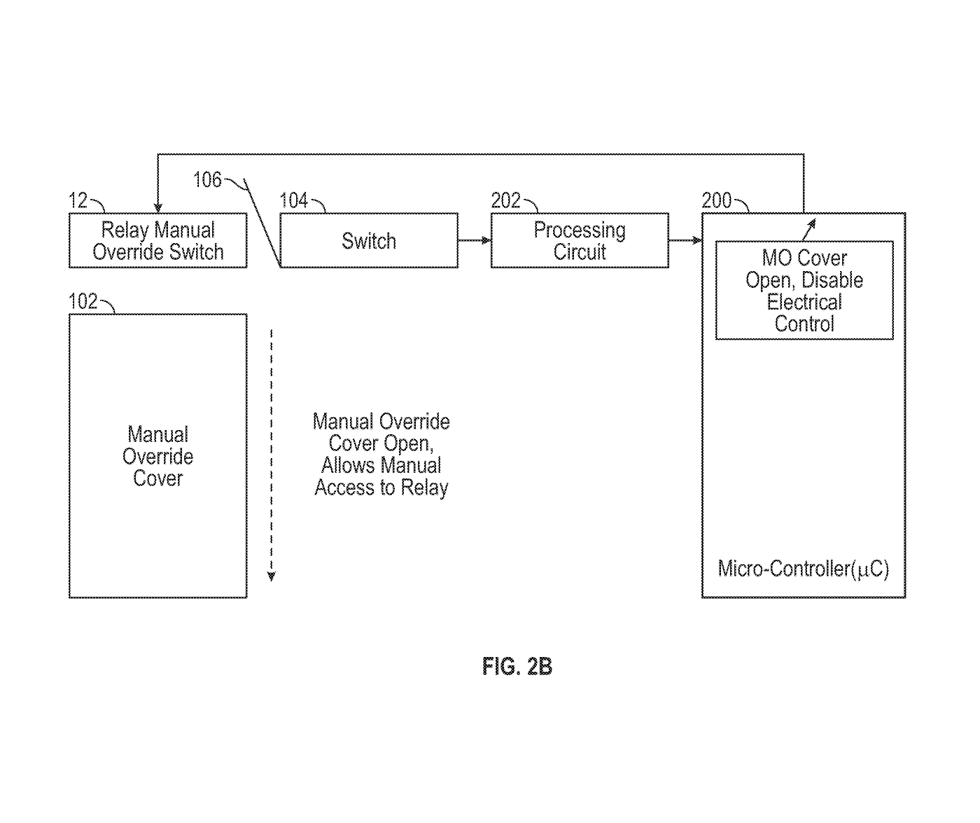

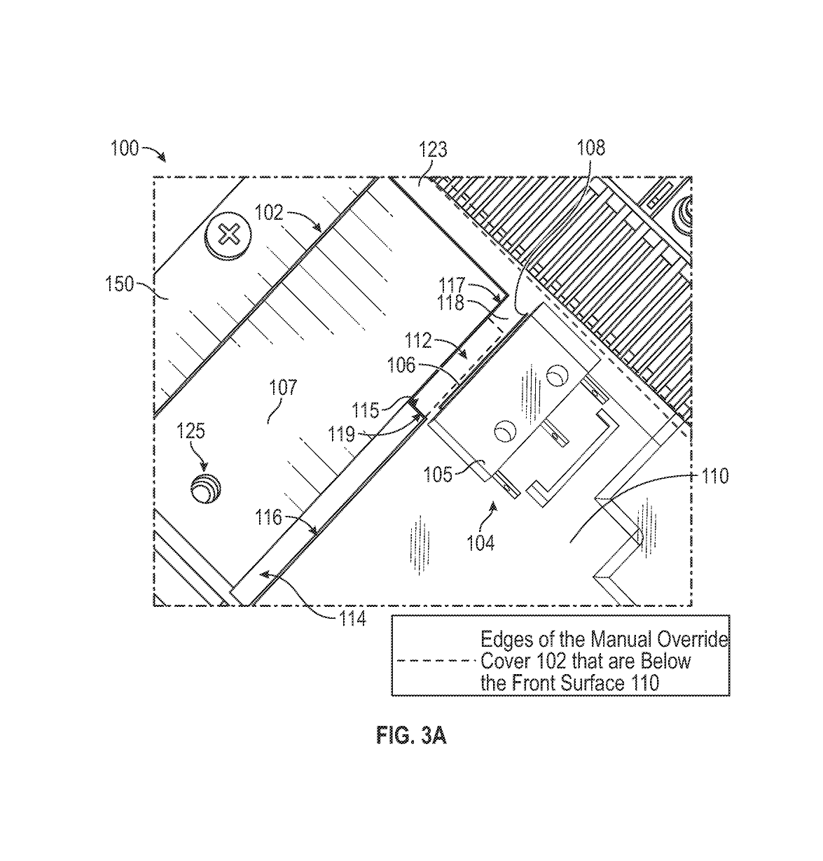

As shown in FIG. 2A and subsequent figures, the MID 10 includes a manual override switch 12, and the manual override switch 12 can be used to manually actuate the MID’s relay device 11 between the ON state and the OFF state. It is noted that, although the presence of the relay device in the MID is indicated in the figures with the reference number 11, the relay device 11 is not visible in the figures due to being located in the interior of the MID 10. The first advantageous aspect of the disclosed manual override safety system 100 is that the system 100 disables electrical control of the MID’s relay device 11 when the MID’s manual override switch 12 is presumed to be in use, as detailed further herein in conjunction with FIGS. 2A-3B. The second advantageous aspect of the manual override safety system 100 is that the system 100 is structured to ensure that the MID 10 will not be manually put into grid-following mode unless a series of specific actions are taken that should not be taken by anyone other than qualified personnel, said actions including removing the dead front cover 20 and being detailed primarily in conjunction with FIGS. 4A-8.

In order to provide a common frame of reference between the figures, various dimensions and directions are labeled in the figures. The labeled dimensions include a depth dimension 501, a width dimension 502, and a height dimension 503. Each of the three dimensions is orthogonal to the other two dimensions. The labeled directions include a forward direction 505 and a rearward direction 507. These forward and rearward directions 505, 507 are in the depth dimension 501. It is noted that components of structures are sometimes referred to herein as being “forward” or “rear”. It should be understood that referring to a component as a “forward [component]” (e.g. a forward edge) herein signifies that said forward component is disposed more forward 505 than other components in the structure. Similarly, it should be understood that referring to a component as a “rear [component]” (e.g. a rear edge) signifies that said rear component is disposed more rearward 507 than other components in the structure. The use of the terms “depth”, “width”, and “height” to refer to the dimensions 501, 502, and 503 and the use of the terms “forward” and “rear[ward]” to refer to the directions 505 and 507 is intended solely to describe the positions of various components in the load panel 1 relative to one another and should not be construed as limiting the orientation in which the load panel 1 can be used.

The features of the manual override safety system 100 that prevent electrical control of the MID relay device 11 when the manual override control is presumed to be in use are discussed hereinafter in conjunction with FIG. 1 and FIGS. 2A-3B. As labeled in FIG. 1, the MID 10 comprises a front cover 101. The front cover 101 is part of the manual override safety system 100 and is coupled to the load panel housing 15. It is noted that some portions of the MID front cover 101 are depicted as transparent in FIGS. 2A and 3A so that the structural relationships between certain features of the manual override safety system 100 are easier to discern. As shown in FIGS. 2A and 3A, the manual override safety system 100 further comprises a manual override cover 102 that is selectively used to cover an opening 103 in the MID front cover 101. The opening 103 is structured to make the manual override switch 12 accessible for manual actuation by a user, as the override switch 12 is disposed within the opening 103.

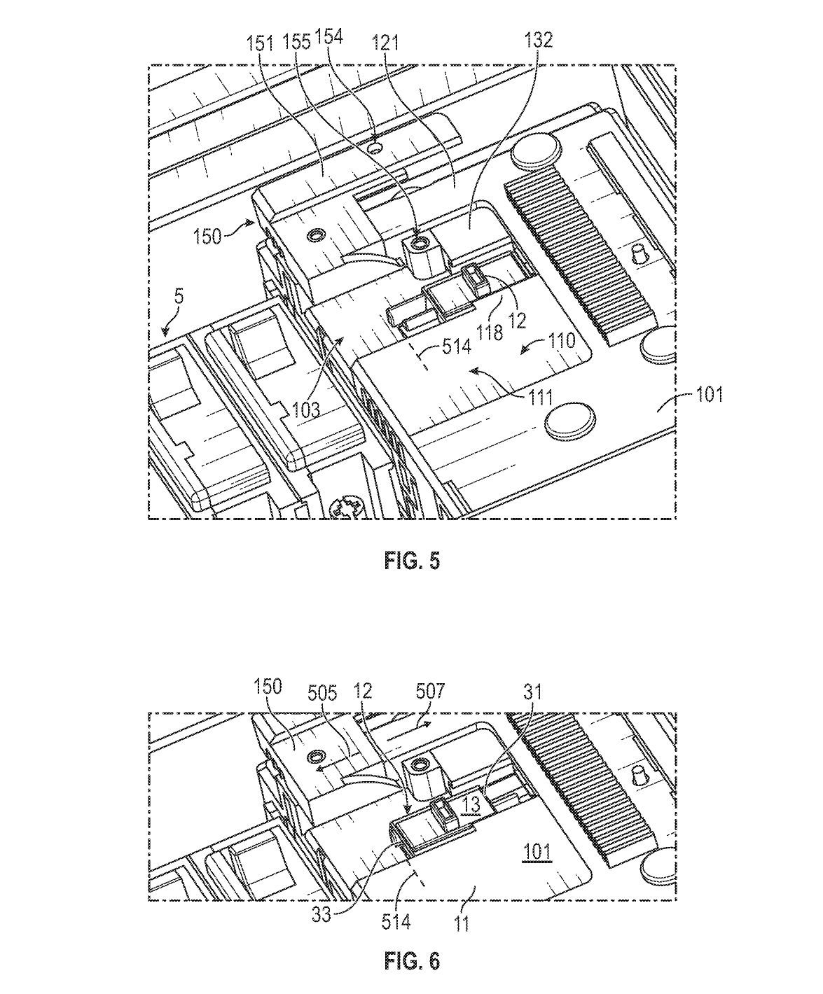

In FIG. 2A, the manual override cover 102 is also numbered with the reference number 102´, because a manual override cover 102´´ shown in FIG. 7 has minor variations compared to the manual override cover 102´ of FIG. 2A. When the prime symbol (i.e. ´ ) is appended to the end of a reference number herein and in the figures, it should be understood that the component being referenced can be referred to generally using the reference number without the prime symbol appended. For example, the manual override covers 102´ and 102´´ can be referred to generally using the reference number 102. The manual override covers 102´ and 102´´ differ from one another only in regard to minor variations to a stopping portion 114 (detailed later herein) and the opening mechanism included in each manual override cover 102. These variations will be detailed later in conjunction with FIG. 7. It is noted that both manual override covers 102´, 102´´ function in the same manner to prevent electrical control of the relay device 11 when the manual override cover 102 is open and to prevent the relay device 11 from being manually put into the grid-following mode when the dead front cover 20 is coupled to the rest of the housing 15.

The manual override safety system 100 further comprises a switch guard 150 that is only partially shown in FIGS. 2A and 3A, as parts of the switch guard 150 are cut away and the MID front cover 101 is shortened in FIGS. 2A and 3A in order to make certain features of the manual override cover 102 more apparent. As detailed further later herein in conjunction with FIG. 4B and subsequent figures, the manual override cover 102 is structured to be coupled to the switch guard 150, and the opening 103 in the MID front cover 101 is structured to receive the switch guard 150 with the manual override cover 102 attached such that the switch guard 150 and manual override cover 102 together can cover the entirety of the opening 103. The switch guard 150 is shown in its entirety and the MID front cover 101 is shown in its full length in FIG. 4A and subsequent figures, and these components are described in detail later herein in conjunction with those figures.

In comparing FIG. 2A and FIG. 3A to one other, it can be seen that the manual override cover 102 is structured to be moved in the depth dimension 501 between an open position (shown in FIG. 2A) and a closed position (shown in FIG. 3A, also shown in FIG. 1). When the manual override cover 102 is in the open position shown in FIG. 2A, there is a gap between the MID front cover 101 and the manual override cover 102 in the depth dimension 501 that exposes the opening 103 and thus makes the manual override switch 12 accessible to a user. When the manual override cover 102 is in the closed position shown in FIG. 3A, the MID front cover 101 and the manual override cover 102 are fully engaged in the depth dimension 501 such that the manual override cover 102 fully covers the manual override switch 12 and no gap exists between the front cover 101 and the manual override cover 102 in the depth dimension 501, thus preventing access to the manual override switch 12.

The manual override system 100 further comprises a limit switch 104 that is covered by the MID front cover 101. As previously noted, some portions of the MID front cover 101 are depicted as transparent in FIGS. 2A and 3A. In particular, the portion of the MID front cover 101 that covers the limit switch 104 is depicted as transparent in FIGS. 2A and 3A, to facilitate a clear understanding of the structural relationship between the limit switch 104 and other components of the manual override safety system 100. The limit switch 104 comprises a main switch body 105 and a switch lever 106 that is rotatably coupled to the main switch body 105. Specifically, a first end (i.e. “attached end”) of the switch lever 106 is coupled to the main switch body 105 while a second end (i.e. a “free end” 108) of the switch lever 106 disposed opposite the first end is not coupled to the main switch body 105, such that the switch lever 106 can rotate about the first end while remaining coupled to the main switch body 105. The switch lever 106 is structured to be actuated between an unengaged position (shown in FIG. 2A) and an engaged position (shown in FIG. 3A). The unengaged position is the position that the switch lever 106 assumes when no outside force acts upon the switch lever 106. The engaged position is a position that the switch lever 106 can only assume when an external force acts upon the switch lever 106. When the switch lever 106 is in the unengaged position (FIG. 2A), the free end 108 of the switch lever 106 is disposed a distance away from the main switch body 105 in the width dimension 502 such that there is a gap between the free end 108 and the main switch body 105. When the switch lever 106 is in the engaged position (FIG. 3A), the free end of the switch lever 106 is disposed adjacent to the main switch body 105 in the width dimension 502.

The manual override cover 102 comprises a main cover body 107 and a switch engaging arm 109 connected to the main cover body 107. The manual override cover 102 and the switch guard 150 are structured to position the switch engaging arm 109 adjacent to the main switch body 105 relative to the width dimension 502 when the manual override cover 102 is coupled to the switch guard 150. It is noted that the switch engaging arm 109 can be said to be adjacent to the main switch body 105 relative to the width dimension 502 even when the manual override cover 102 is in the open position (as shown in FIG. 2A) and not disposed as far rearward 507 as the main switch body 105. The MID front cover 101 has a front surface 110, and the limit switch 104 is positioned beneath the front surface 110 such that the limit switch 106 is disposed entirely within the interior of the MID 30. The portion of the MID front cover 101 that covers the limit switch 106 can be referred to as the switch covering section 111 of the MID front cover 101.

The switch engaging arm 109 comprises two portions, a switch actuating portion 112 and a stopping portion 114. A front surface 114A of the stopping portion 114 is disposed at a different height in the height dimension 503 than a front surface 112A of the switch actuating portion 112, such that a riser 115 is formed where the front surface 112A of the switch actuating portion 112 and the front surface 114A of the stopping portion 114 meet. The switch covering section 111 of the front cover 101 comprises two lengths in the width dimension 502 such that two edges are formed in the switch covering section 111, a cover arm adjacent edge 116 and a cover body adjacent edge 117, with the cover arm adjacent edge 116 being closer to the main switch body 105 in the width dimension 502 than the cover body adjacent edge 117 is.

The displacement of the cover body adjacent edge 117 relative to the cover arm adjacent edge 116 in the width dimension 502 results in the switch covering section 111 having an arm stop ledge 118 adjacent to the opening 103. The limit switch 104 overlaps with the arm stop ledge 118 in the depth dimension 501 but does not overlap with the cover arm adjacent edge 116 in the depth dimension 501. The arm stop ledge 118 has an arm engaging surface 119 that extends in the width dimension 502 between the cover arm adjacent edge 116 and the cover body adjacent edge 117. When the manual override cover 102 is in the closed position shown in FIG. 3A, the arm engaging surface 119 interfaces with the riser 115, the entirety of the cover body adjacent edge 117 interfaces with the main cover body 107, and the entirety of the cover arm adjacent edge 116 interfaces with the stopping portion 114.

The switch engaging arm 109 of the manual override cover 102 is proportioned so that, when the manual override cover 102 is closed, the stopping portion 114 is level with the arm stop ledge 118 of the front cover 101 in the height dimension 503 and so that the switch actuating portion 112 is disposed underneath the arm stop ledge 118 in the height dimension 503. As such, when the manual override cover 102 is actuated in the depth dimension 501 from the open position (FIG. 2A) to the closed position (FIG. 3A), the switch actuating portion 112 slides underneath the arm stop ledge 118 and engages (i.e. pushes) the switch lever 106 once the switch actuating portion 112 overlaps with the arm stop ledge 118 in the depth dimension 501. It will be appreciated from viewing FIG. 3A in conjunction with FIG. 2A that the manual override cover 102 is in the closed position once the riser 115 of the manual override cover 102 engages the arm stop ledge 118 (and specifically, the arm engaging surface 119) of the MID front cover 101.

It is noted that, relative to the width dimension 502, the switch covering section 111 of the MID front cover 101 is positioned on a first side of the manual override cover 102. The opening 103 is formed in the MID front cover 101 such that the MID front cover 101 comprises a lateral section 121 positioned on a second side of the manual override cover 102 relative to the width dimension 502, the second side being disposed opposite the first side. A bridge portion 123 of the MID front cover 101 connects the switch covering section 111 to the lateral section 121. When the manual override cover 102 is in the closed position, in addition to engaging the arm engaging surface 119 of the MID front cover 101, the manual override cover 102 also engages the bridge portion 123.

The manual override safety system 100 further comprises a controller 200 configured to receive an output signal from limit switch 104 that indicates the state of the switch lever 106, i.e. whether the switch lever 106 is in the unengaged position shown in FIG. 2A or in the engaged position shown in FIG. 3A (i.e. wherein the switch lever 106 is engaged by the switch actuating portion 112). As shown in FIGS. 2B and 3B, a processing circuit 202 can be used to convert the output of the limit switch 104 into a signal used by the controller 200 to determine the state of the switch lever 106. The controller 200 is configured to disable the electrical control of the relay device 11 when the switch lever 106 is in the unengaged position shown in FIG. 2A, as the switch lever 106 being in the unengaged position signifies that the manual override cover 102 is open and that the manual override switch 12 is accessible to a user.

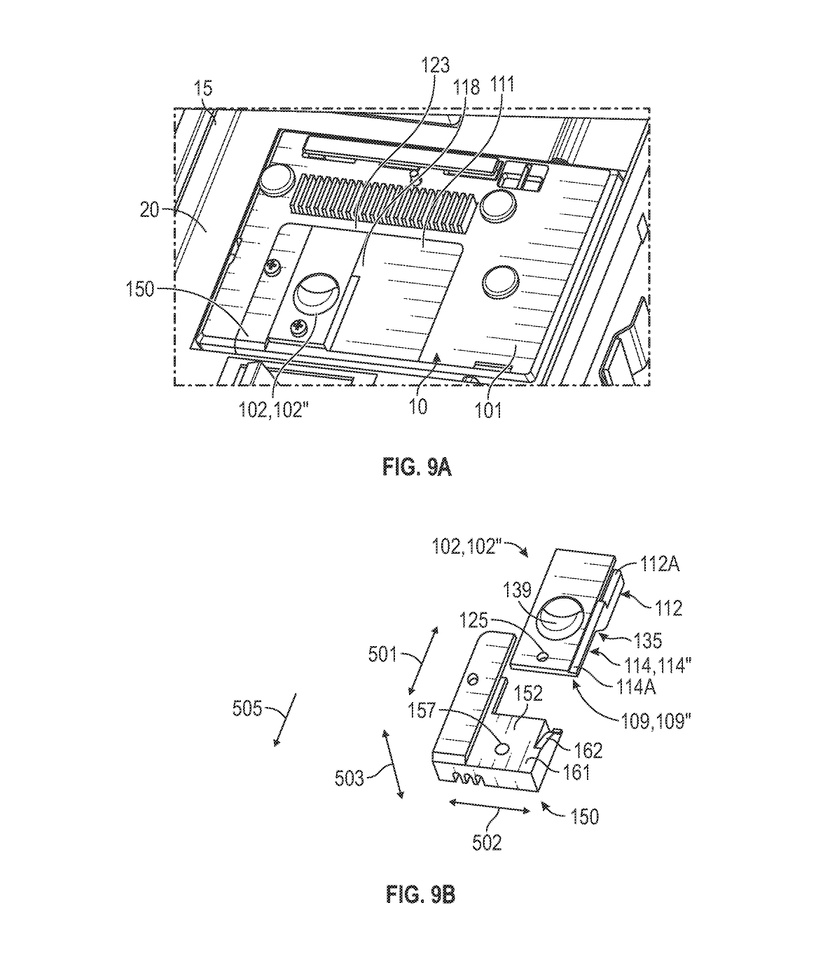

The manual override safety system 100 is designed under the assumption that the manual override cover 102 would only be open if a user were actively trying to use the manual override switch 12. As numbered in FIG. 3A, the manual override cover 102 is formed with an aperture 125, and in order to secure the manual override cover 102 in the closed position, the manual override cover 102 must be positioned so that the aperture 125 aligns with a corresponding aperture formed in the switch guard 150 so that a fastener such as a screw can be inserted through the aperture 125 and through the corresponding aperture in the switch guard 150 (also discussed later herein in conjunction with FIGS. 9A-9B).

It is noted that the electrical control of the relay device 11 is used to automatically change the state of the relay device 11 based on predefined conditions. In addition, electrical control of the relay device 11 can also be used to enable a user to remotely change the state of the relay device. The feature of disabling electrical control functionality when the manual override cover 102 is open is advantageous, because when the manual override cover 102 is open, the manual override function is either being used (i.e. a user is actuating the manual override switch 12 to the OFF state) or is about to be used (which can be assumed from the manual override cover 102 being open). This prevents there being any conflicts between manual override actions taken in close proximity to automated/remote commands for electrical control, since the manual override function is given priority over the electrical control.

Reference is now made to FIGS. 4A-4B and subsequent figures to discuss the features of the manual override safety system 100 that are designed to ensure that the MID 10 cannot manually be put into grid-following mode unless a series of specific actions are taken that should not be taken by anyone other than qualified personnel. That is, in addition to preventing use of the electrical control when the manual override switch 12 is being used or is about to be used, as previously described herein in conjunction with FIGS. 2A-3B, the manual override safety system 100 maximizes the likelihood of the manual override switch 12 only being switched from the OFF position to the ON position when it is safe to do so.

The features of the manual override safety system 100 that prevent the MID 10 from manually being put into grid-following mode only work when the dead front cover 20 is coupled to the rest of the load panel housing 15. Hereinafter, when the term “installed” is used in relation to the dead front cover 20, this will denote that the dead front cover 20 is coupled to the rest of the load panel housing 15. Conversely, when the term “uninstalled” is used hereinafter in relation to the dead front cover 20, this will denote that the dead front cover 20 has been uncoupled from the rest of the load panel housing 15. It is noted that, when the dead front cover 20 is installed, a forward side 131 (numbered in FIG. 4B) of the MID front cover 101 is adjacent to the dead front cover 20. The opening 103 formed in the MID front cover 101 extends from the forward side 131 to the bridge portion 123, such that the bridge portion 123 is disposed on the rear end of the opening 103 and the forward end of the opening 103 is formed on the forward side 131. As previously noted, the MID front cover 101 was shortened in FIGS. 2A and 3A in order to make certain features of the manual override cover 102 more apparent, and it is noted that the forward side 131 of the MID front cover 101 extends further forward 505 in FIGS. 4A-4B and subsequent figures than portrayed in FIGS. 2A and 3A. It is further noted that when the dead front cover 20 is installed, no live portion of the load panel 1 (e.g. the main bus 7) is accessible, which is ensured in part by the dead front cover 20 being adjacent to the MID front cover 101.

The manual override switch 12 is used during installation of a DER into the microgrid managed by the load panel 1 as well as in the case of the DER not working or any time that a forced command needs to be provided. In a scenario where a DER is ON and in grid-forming mode (i.e. isolated from the utility grid), it is undesirable to allow the manual override switch 12 to be actuated from its OFF position to its ON position without first ensuring that the DER output is synchronized with the utility grid, otherwise the DER will pass AC current to the grid that is out of phase with the grid (since actuating the manual override switch 12 to the ON position will connect the DER to the utility grid). As such, it is typically preferable to only allow the DER to be put into grid-following mode using the electrical control of the MID 10, i.e. such that the MID 10 and the DER must exchange automated electrical communications to automatically synchronize the DER to the grid before the MID 10 puts its relay device 11 into the ON state. However, the ability to actuate the manual override switch 12 from its OFF position to its ON position is needed under certain conditions, such as a scenario where the DER goes OFF while in the grid-forming mode prior to the MID putting its relay device 11 into the grid-following mode. In this scenario, the manual override switch 12 needs to be manually actuated from its OFF position to its ON position so that the MID can connect the main bus 7 to utility power.

As briefly noted earlier herein, the manual override safety system 100 includes a switch guard 150 which the manual override cover 102 gets coupled to in order to cover the manual override switch 12 when the manual override switch 12 is not in use. FIG. 4A shows the load panel 1 with the dead front cover 20 uninstalled and the manual override cover 102 removed from the switch guard 150, and FIG. 4B shows an enlarged view of a portion of FIG. 4A that shows the manual override switch 12 and switch guard 150 more closely. The switch guard 150 is advantageously designed to restrict movement of the manual override switch 12 such that the manual override switch 12 cannot be manually actuated to the ON position when the switch guard 150 is fully inserted within the opening 103. In addition, the switch guard 150 is advantageously designed such that it cannot be uncoupled from the MID front cover 101 and removed from the opening 103 when the dead front cover 20 is installed. By requiring the dead front cover 20 to be uninstalled before the switch guard 150 can be removed from the opening 103, and by requiring that the switch guard 150 be removed from the opening 103 before the manual override switch 12 can be actuated to the ON/grid-following position, the manual override safety system 100 maximizes the likelihood of the manual override switch 12 only being moved from the OFF position to the ON position when it is safe to do so, as dead front covers should only be removed by qualified personnel.

Hereinafter, the term “restricting position” will be used to refer to the switch guard 150 being positioned fully within the opening 103, as shown in FIGS. 1, 2A, 3A, and 4A-4B. As detailed further later herein, in the restricting position, the switch guard 150 prevents the manual override switch 12 from being actuated to its ON position. The switch guard 150 is considered to be in a non-restricting position it is unable to prevent the manual override switch 12 from being actuated to its ON position. In particular, the switch guard 150 is in a non-restricting position any time it is not positioned fully within the opening 103 and not engaging both the bridge portion 123 and the cover arm adjacent edge 116. As labeled in FIG. 4B, the switch guard 150 comprises an anchoring portion 151 and a motion restrictor 152 that extends from the anchoring portion 151. The anchoring portion 151 extends the entire length of the opening 103 in the depth dimension 501 and is adjacent to the lateral section 121, and the motion restrictor 152 extends in the width dimension 502 from the anchoring portion 151 to the switch covering section 111. In the restricting position, the rear end of the anchoring portion 151 engages the bridge portion 123 and the motion restrictor 152 engages the cover arm adjacent edge 116. Another indication of the switch guard 150 being in the restricting position is that a forward edge 153 of the switch guard 150 is flush with the forward side 131 of the MID front cover 101 in the depth dimension 501. When the switch guard 150 is in its restricting position with the manual override cover 102 attached and the manual override cover 102 is closed, the switch guard 150 and manual override cover 102 together cover the entirety of the opening 103 (i.e. as shown in FIGS. 3A and 9).

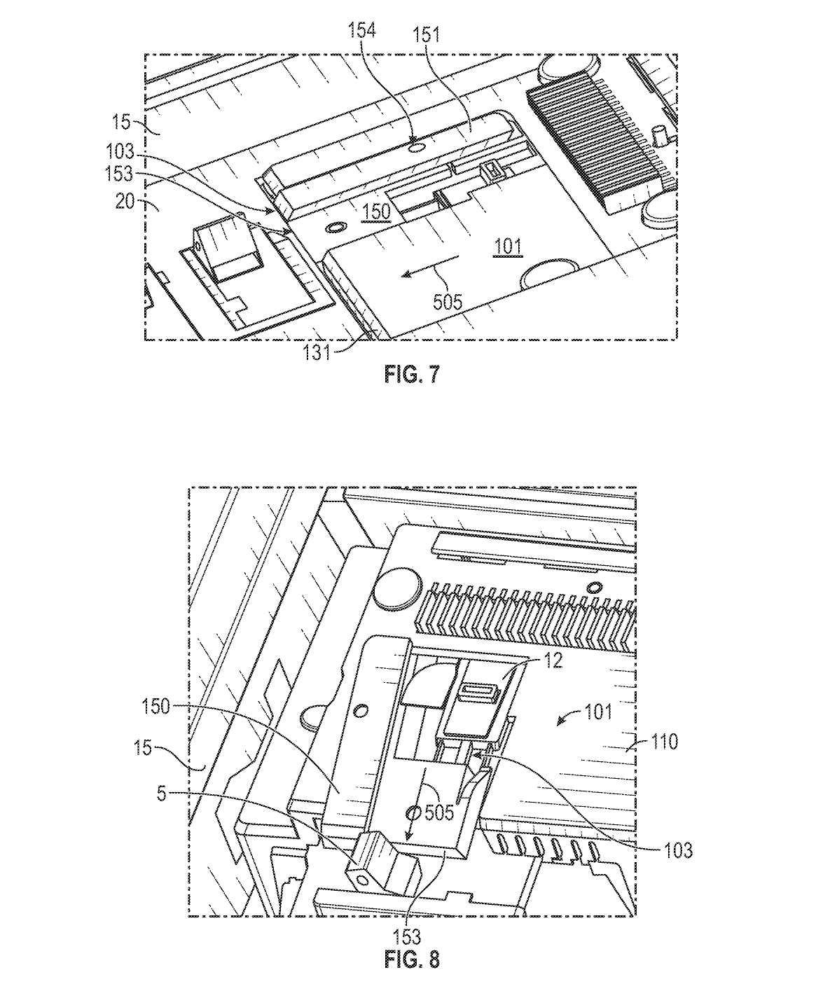

The anchoring portion 151 is used to anchor the switch guard 150 in its restricted position. Specifically, the MID front cover 101 comprises an anchor block 132 that is disposed below the front surface 110 in the height dimension 503, and the anchoring portion 151 is structured to be coupled to the anchor block 132. In the figures, the anchoring portion 151 is formed with an aperture 154 and the anchor block 132 is formed with a corresponding aperture 155, and switch guard 150 can be coupled to the MID front cover 101 by positioning the anchoring portion 151 so that the apertures 154 and 155 align and inserting a fastener such as a screw through the aligned apertures 154, 155. However, other fastening means can be used to couple the anchoring portion 151 to the MID front cover 101 without departing from the scope of the disclosed concept. As detailed later herein in conjunction with FIGS. 7-8, it is noted that the switch guard 150 is actually proportioned to not be removable from the MID 10 when the dead front cover 20 is installed, so inserting a fastener through the apertures 154, 155 is not strictly necessary, but most users would likely consider it desirable to use a fastener so that the switch guard 150 cannot wiggle.

The OFF position of the manual override switch 12 corresponds to the MID relay device 11 being in an OFF state, which is also referred to as the grid-forming mode (wherein all DERs connected to the MID 100 are isolated from the utility grid), and the ON position of the manual override switch 12 corresponds to the MID relay device 11 being in an ON state, which is also referred to as the grid-following mode (wherein any DER connected to the MID 100 can be connected to the utility grid). The manual override switch 12 comprises a base portion 13 and a handle portion 14 that extends from the base portion 13. In FIG. 4B, the OFF/grid-forming position of the manual override switch 12 is indicated with the dashed line 512 and the ON/grid-following position of the manual override switch 12 is indicated with the dashed line 514. More specifically, the manual override switch 12 is in the OFF/grid-forming position 512 when a rear edge 31 of the base portion 13 is aligned with the dashed line 512 (indicating that the base portion 13 is abutting the bridge portion 123), and the manual override switch 12 is in the ON/grid-following position 514 when a forward edge 33 of the base portion 13 is aligned with the dashed line 514. The OFF/grid-forming position 512 is the furthest that the manual override switch 12 can move in the rearward direction 507. When the switch guard 150 is removed from the opening 103, the ON/grid-following position 514 is the furthest that the manual override switch 12 can move in the forward direction 505.

When the switch guard 150 is in its restricting position shown in FIG. 4B, the motion restrictor 152 overlaps with the base portion 13 of the manual override switch 12 in the height dimension 503, and as such, the switch guard 150 prevents the base portion 13 from being able to move far enough forward 505 to be alignment with the dashed line 514 and thus prevents the manual override switch 12 from being moved to the ON/grid-following position 514. Specifically, a rear edge 158 of the motion restrictor 152 obstructs the base portion 13 of the manual override switch 12 from moving any further forward 505 once the forward edge of the base portion 13 engages the rear edge 158. In addition to the OFF and ON positions 512, 514, the manual override switch 12 can also be disposed in a center position 516 disposed between the OFF and ON positions 512, 514, with the center position 516 being that in which the handle portion 14 is centered with the dashed line 516. When the manual override switch 12 is in the center position 516, the electrical control of the MID 10 controls whether the relay device 11 is in the OFF state or the ON state.

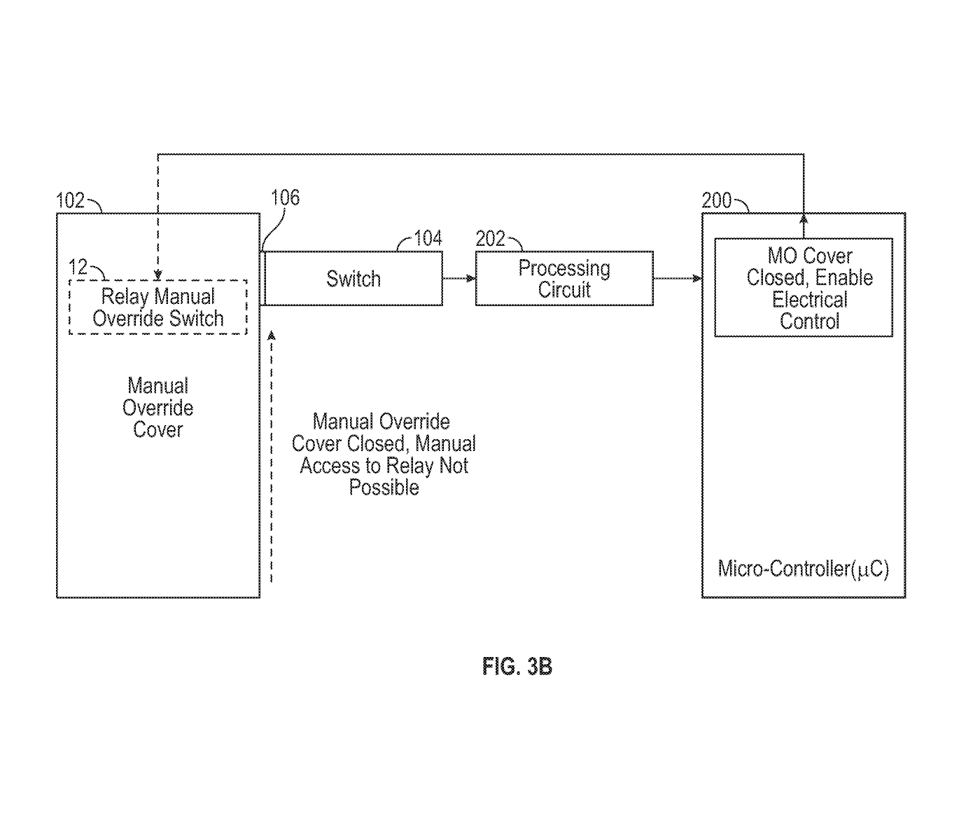

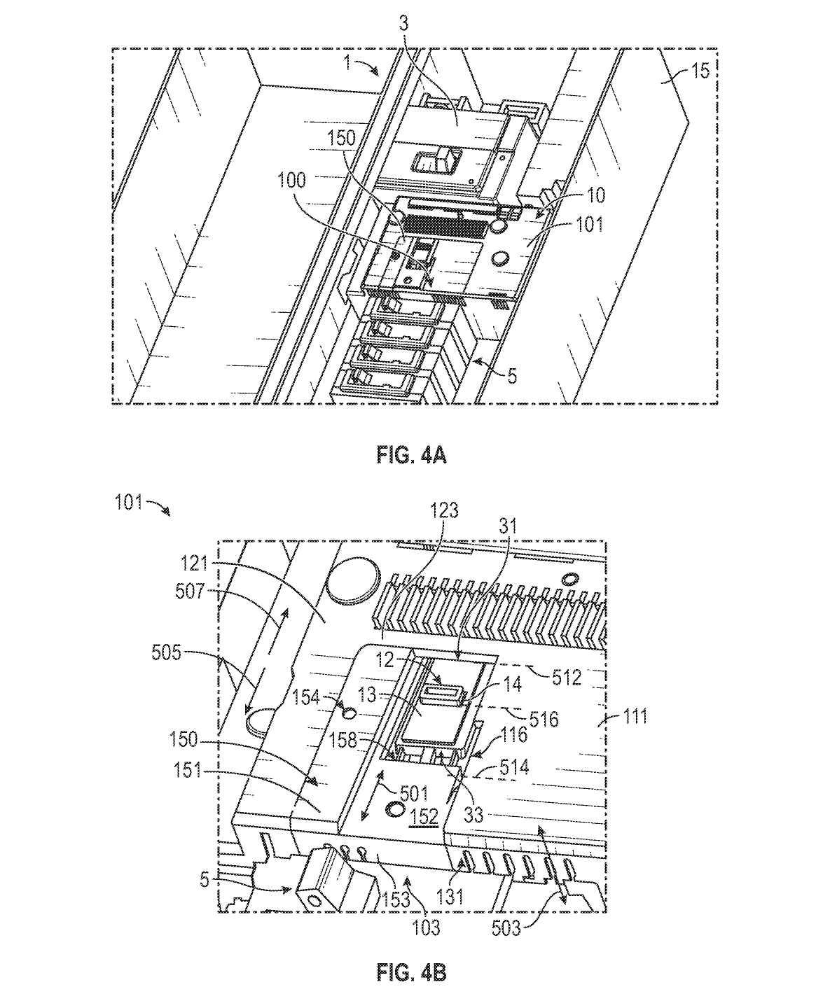

FIG. 5 shows how the switch guard 150 can be removed from covering the opening 103 when it is desired to move the manual override switch 12 to the ON/grid-following position 514. Once the fastener (e.g. screw) that couples the anchoring portion 151 to the MID front housing 101 is removed from the apertures 154 and 155, the switch guard 150 can be lifted off of the opening 103. The arrows in FIG. 5 are included to demonstrate that the switch guard 150 was removed from the opening 103. In FIG. 5, the manual override switch 12 is in the OFF/grid-forming position 512. In FIG. 6, the manual override switch 12 is shown in the ON/grid-following position 514, which was made possible by removing the switch guard 150 and thus removing the obstruction to the base portion 13 being able to move sufficiently forward 505 so that the forward edge 33 can be aligned with the dashed line 514.

Reference is now made to FIG. 7 to detail how the switch guard 150 is advantageously structured to prevent its removal from the opening 103 when the dead front cover 20 is installed. In FIG. 7, the fastener (e.g. screw) that couples the anchoring portion 151 to the MID front housing 101 has been removed from the apertures 154 and 155, but as shown in FIG. 7, when the dead front cover 20 is installed, there is not enough clearance between the forward edge 131 of the MID front cover 101 and the dead front cover 20 to enable the switch guard 150 to be removed from the opening 103, as the forward edge 153 of the switch guard 150 gets caught in the nearest edge of the dead front cover 20 when the switch guard 150 is moved forward 505 from the restricting position. When the dead front cover 20 is in place, there is a specific portion of the dead front cover 20 that restricts the forward 505 movement of the switch guard 150, said specific portion being positioned between the switch guard’s forward edge 153 and the handle for the branch breaker 5 that is nearest the forward edge 153. FIG. 8 shows how removing the dead front cover 20 provides enough clearance for the switch guard 150 to be moved sufficiently forward 505 to be removed from the opening 103. In particular, as shown in FIG. 8, the switch guard 150 can be moved forward 505 until its forward edge 153 encounters the handle for the nearest branch breaker 5 and can then be tilted upward, i.e. away from the front surface 110 of the MID front cover 101, and picked up out of the opening 103.

The minor variations between the manual override cover 102´ shown in FIGS. 2A and 3A and the manual override cover 102´´ shown in FIGS. 9A-9B will now be detailed. As can be seen when comparing FIGS. 9A-9B to FIG. 2A, the manual override covers 102´ and 102´´ differ primarily in the structure of their respective switch engaging arms 109, due to there being variations in the structures of their respective stopping portions 114. In particular, in the manual override cover 102´ (FIG. 2A), the bottom edge of the entire switch engaging arm 109 is in the same plane relative to the height dimension 503, such that the bottom edge of the switch actuating portion 112 and the bottom edge of the stopping portion 114 are positioned at the same height in the height dimension 503. In contrast, in the manual override cover 102´´ (FIG. 9B), the stopping portion 114´´ has a portion cut out from its bottom side (compared to the stopping portion 114´ of FIG. 2A) such that the bottom edge of the switch actuating portion 112 is positioned at a lower height in the height dimension 503 than the bottom edge of the stopping portion 114´´, leading to the switch engaging arm 109´´ having a slope 135 on its bottom side.

Referring to the switch guard 150 as shown in FIG. 9B, the motion restrictor 152 comprises a planar portion 161 and a curved portion 162 that is positioned to be engaged by the slope 135 of the manual override cover 102´´. As briefly mentioned earlier herein, and as numbered in FIG. 3A and FIG. 9B, the manual override cover 102 is formed with an aperture 125 and the motion restrictor 152 is formed with an aperture 157, and in order to secure the manual override cover 102 in the closed position, the manual override cover 102 must be positioned with the aperture 125 aligning with the aperture 157 so that a fastener such as a screw can be inserted through the two apertures 125, 157.

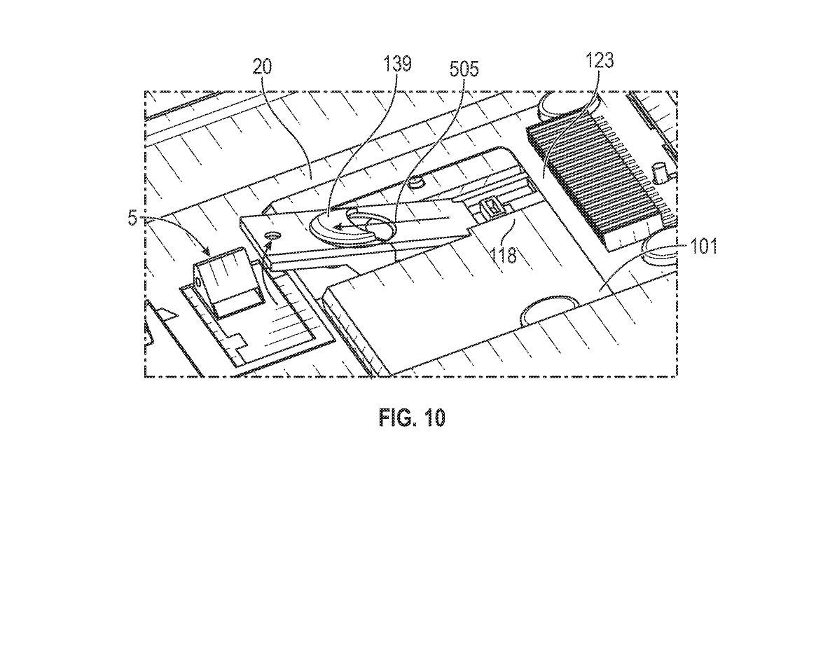

Referring to FIG. 10 in conjunction with FIGS. 9A-9B, when opening the manual override cover 102´´ is desired, the screw must be removed, and the manual cover 102´´ must first be slid forward 505 away from the bridge portion 123 of the MID front cover 101 so that the switch actuating portion 112 moves forward and out from underneath the arm stop ledge 118 of the MID front cover 101. Next, a pull tab 139 formed on the manual override cover 102´´ can be pulled on to lift the manual override cover 102´´ away from the switch guard 150. This motion is depicted in FIG. 10 can be used simply to open the manual override cover 102´´ or remove it from the switch guard 150 altogether. The engagement between the slope 135 of the manual override cover 102´´ and the curved portion 162 of the motion restrictor 152 makes removing the manual override cover 102 from the opening 103 easier, as the slope 135 can roll against the curved portion 162 when a user pulls on the pull tab 139, such that the manual override cover 102´´ rotates relative to the MID front cover 101 and the dead front cover 20, as shown in FIG. 10. In contrast, the manual override cover 102´ (FIG. 2A) is structured to simply slide linearly forward 505.

It is noted that the features of the manual override cover 102´´ that differentiate it from the manual override cover 102´ (i.e. the formation of the slope 135 and the inclusion of the tab 139) are directed solely toward making removal of the manual override cover 102 from the switch guard 150 easier from a fine motor skill standpoint. As previously stated, the differences between the two manual override cover embodiments 102´, 102´´ do not affect the ability of both manual override covers 102´, 102´´ to function in the same manner to prevent electrical control of the relay device 11 when the manual override cover 102 is open and to prevent the relay device 11 from being manually put into the grid-following mode when the dead front cover 20 is coupled to the rest of the housing 15. That is, for both the manual override cover 102´ and the manual override cover 102´´, when moving the manual override cover 102 into the closed position, the switch actuating portion 112 slides underneath the arm stop ledge 118 and engages the switch lever 106 once the switch actuating portion 112 overlaps with the arm stop ledge 118 in the depth dimension 501. In addition, for both the manual override cover 102´ and the manual override cover 102´´, the dead front cover 20 must be removed in order for the switch guard 150 to be removed from the opening 103. As such, it will be appreciated that the switch guard 150 can be structured for use with the manual override cover 102´ by forming the motion restrictor 152 to only have the planar portion 161 without the curved portion 162 so that the manual override cover 102´ can removed from the switch guard 150 solely by being slid linearly in the depth dimension 501.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A manual override safety system for an MID installed in a load panel, the load panel comprising a load panel housing with a dead front cover, the MID including a relay device and a manual override switch that can be manually actuated in a depth dimension between an OFF position corresponding to the relay device being in a grid-forming state and an ON position corresponding to the relay device being in a grid-following state, the manual override safety system comprising:
an MID front cover, the MID front cover comprising:
an opening structured to make the manual override switch accessible for manual actuation;
a switch guard structured to be positioned fully within the opening and coupled to the MID front cover;
a manual override cover structured to be coupled to the switch guard;
a limit switch covered by the MID front cover, the limit switch comprising:
a main switch body; and
a switch lever, the switch lever being structured to be actuated between an unengaged position and an engaged position; and
a controller in electrical communication with the limit switch,
wherein the manual override cover is structured to be moved between an open position and a closed position such that the manual override cover exposes the manual override switch in the open position and covers the manual override switch in the closed position,
wherein the manual override cover and the limit switch are positioned such that the manual override cover being in the open position causes the switch lever to be in the unengaged position and such that the manual override cover being in the closed position causes switch lever to be in the engaged position,
wherein the controller is configured to disable electrical control of the relay device when the switch lever is in the unengaged position, and
wherein the switch guard is structured such that, when coupled to the MID front cover and positioned fully within the opening, the switch guard obstructs the manual override switch from being actuated to the ON position.

2. The manual override safety system of claim 1,
wherein the switch guard is structured such that it cannot be uncoupled from the MID front cover and removed from the opening unless the dead front cover is uninstalled from the load panel housing.

3. The manual override safety system of claim 1,
wherein the manual override cover is structured such that, when the manual override cover is actuated from the open position to the closed position, the manual override cover pushes the switch lever from the unengaged position to the engaged position.

4. The manual override safety system of claim 1,
wherein the manual override cover comprises:
a main cover body; and
a switch engaging arm, and
wherein the manual override cover and the switch guard are structured such that, when the manual override cover is coupled to the switch guard, the switch engaging arm is positioned adjacent to the main switch body relative to a width dimension, the width dimension being orthogonal to the depth dimension.

5. The manual override safety system of claim 4,
wherein the MID front cover comprises an arm stop ledge adjacent the opening.

6. The manual override safety system of claim 5,
wherein the opening extends in the depth dimension and the width dimension.

7. The manual override safety system of claim 6,
wherein the MID front cover comprises a switch covering section that covers the limit switch and is disposed on a first side of the opening,
wherein the switch covering section comprises two lengths in the width dimension such that two edges are formed in the switch covering section, the two edges including a cover arm adjacent edge and a cover body adjacent edge, the cover body adjacent edge being on the arm stop ledge, with the cover arm adjacent edge being closer to the main switch body in the width dimension than the cover body adjacent edge is,
wherein the arm stop ledge is formed by the displacement of the cover body adjacent edge relative to the cover arm adjacent edge in the width dimension,
wherein the switch engaging arm of the manual override cover comprises a switch actuating portion and a stopping portion, with a front surface of the switch actuating portion being disposed at a lower height in a height dimension than a front surface of the stopping portion such that a riser is formed where the front surface of the switch actuating portion and the front surface of the stopping portion meet, the height dimension being orthogonal to both the depth dimension and the width dimension, and
wherein the switch engaging arm is structured such that, when the manual override cover is actuated from the open position to the closed position, the switch actuating portion slides underneath the arm stop ledge and pushes the switch lever into the engaged position once the switch actuating portion overlaps with the arm stop ledge in the depth dimension.

8. A manual override safety system for an MID installed in a load panel, the load panel comprising a load panel housing with a dead front cover, the MID including a relay device and a manual override switch that can be manually actuated in a depth dimension between an OFF position corresponding to the relay device being in a grid-forming state and an ON position corresponding to the relay device being in a grid-following state, the manual override safety system comprising:
an MID front cover, the MID front cover comprising:
an opening structured to make the manual override switch accessible for manual actuation, the opening extending in the depth dimension and a width dimension, the width dimension being orthogonal to the depth dimension; and
an arm stop ledge adjacent the opening;
a switch guard structured to be positioned fully within the opening and coupled to the MID front cover;
a manual override cover structured to be coupled to the switch guard, the manual override cover comprising:
a main cover body; and
a switch engaging arm;
a limit switch covered by the MID front cover, the limit switch comprising:
a main switch body; and
a switch lever, the switch lever being structured to be actuated between an unengaged position and an engaged position; and
a controller in electrical communication with the limit switch,
wherein the manual override cover is structured to be moved between an open position and a closed position such that the manual override cover exposes the manual override switch in the open position and covers the manual override switch in the closed position,
wherein the manual override cover and the limit switch are positioned such that the manual override cover being in the open position causes the switch lever to be in the unengaged position and such that the manual override cover being in the closed position causes switch lever to be in the engaged position,
wherein the controller is configured to disable electrical control of the relay device when the switch lever is in the unengaged position, and
wherein the switch guard is structured such that, when coupled to the MID front cover and positioned fully within the opening, the switch guard obstructs the manual override switch from being actuated to the ON position.

9. The manual override safety system of claim 8,
wherein the switch guard is structured such that it cannot be uncoupled from the MID front cover and removed from the opening unless the dead front cover is uninstalled from the load panel housing.

10. The manual override safety system of claim 8,
wherein the manual override cover is structured such that, when the manual override cover is actuated from the open position to the closed position, the manual override cover pushes the switch lever from the unengaged position to the engaged position.

11. The manual override safety system of claim 8,
wherein the manual override cover and the switch guard are structured such that, when the manual override cover is coupled to the switch guard, the switch engaging arm is positioned adjacent to the main switch body relative to the width dimension.

12. The manual override safety system of claim 11,
wherein the MID front cover comprises a switch covering section that covers the limit switch and is disposed on a first side of the opening,
wherein the switch covering section comprises two lengths in the width dimension such that two edges are formed in the switch covering section, the two edges including a cover arm adjacent edge and a cover body adjacent edge, the cover body adjacent edge being on the arm stop ledge, with the cover arm adjacent edge being closer to the main switch body in the width dimension than the cover body adjacent edge is,
wherein the arm stop ledge is formed by the displacement of the cover body adjacent edge relative to the cover arm adjacent edge in the width dimension,
wherein the switch engaging arm of the manual override cover comprises a switch actuating portion and a stopping portion, with a front surface of the switch actuating portion being disposed at a lower height in a height dimension than a front surface of the stopping portion such that a riser is formed where the front surface of the switch actuating portion and the front surface of the stopping portion meet, the height dimension being orthogonal to both the depth dimension and the width dimension, and
wherein the switch engaging arm is structured such that, when the manual override cover is actuated from the open position to the closed position, the switch actuating portion slides underneath the arm stop ledge and pushes the switch lever into the engaged position once the switch actuating portion overlaps with the arm stop ledge in the depth dimension.
